(19) United States
(12) Patent Application Publication
(10) Pub. No.: US 2005/0057455 A1
(43) Pub. Date: Mar. 17, 2005

(54) Driving device and method for display period control of organic light emitting diode

(76) Inventor: Jen-Chun Peng, HsinChu City (TW)

Correspondence Address: BIRCH STEWART KOLASCH & BIRCH, PO BOX 747, FALLS CHURCH, VA, 22040-0747, US

(21) Appl. No.: 10/651,980

(22) Filed: Sep. 2, 2003

(51) Int. Cl. G09G 3/30

(52) U.S. Cl. 345/76

(57) ABSTRACT

The present invention is directed to a driving device and method for display period control of organic light emitting diode (OLED). A driving device includes a current buffer, a switching unit and a pulse width modulation (PWM) grayscale control unit. The current buffer is connected to an external current source providing constant current. The switching unit is connected to an external precharge voltage supply, a current buffer and analog grounding with an output connected to OLED. The PWM grayscale control unit is connected to an external memory and a switching unit for receiving start signal and grayscale display control in accordance with the image data transmitted by the memory. Grayscale is controlled according to the display phase during the display period for division of grayscale display duration in proportion to the individual grayscales corresponding to image data. Upon receiving image data, the driving device makes time control between the current buffer and OLED in compliance with corresponding grayscale display duration to achieve the purpose of grayscale display control.

### FIELD OF THE INVENTION

The present invention relates to a driving device for organic light emitting diode. More particularly, the invention is directed to the driving device and method for display period control of organic light emitting diodes (OLED).

### BACKGROUND OF THE INVENTION

The OLED display, a new generation flat display technology, uses the theory of organic light-emitting diodes (OLED). When the organic compound material of sandwich formed OLED is imposed current through by positive and negative electrodes of the OLED, the material excites visible light. That is, the organic thin film in OLED will become self-emitting after reaching to a certain current capacity and no back-light source and color filter are required. Thus, the OLED display is a current-controlled device. In other words, emitting of each pixel can be achieved through control of current capacity.

Whereas, most of the OLED display products on the market are monochrome forms. Among monochrome OLED display products, the feature of different light and shade can only be developed via current control characteristics. For instance, the shading value of the OLED display can be determined by the current passing through the organic thin film and different grayscales may apply different current sources to drive various shades. This approach is not only complicated for hardware design, but also leads to an increase requirement of hardware when higher grayscale levels is demanded, and leads to design inflexibility as well.

Furthermore, a complete OLED display period includes precharge phase, display phase and discharge phase. The precharge phase makes way for smooth operation of the following display phase. A complete display period won't be finished until the current-controlled OLED display has emitted (display phase) and discharged. Thus, how to design a simple control circuit that enables the OLED display to control display period with monochromatic light having grayscale features has become an aspiring objective for R&D personnel.

### SUMMARY OF THE INVENTION

In addition to the choice of emitting and not emitting and discriminative brightness, the precharge duration and discharge duration have to be set for different panels in order to maintain good display quality.

To achieve the aforementioned purpose, the present invention provides a driving device that controls the display period of organic light-emitting diodes (OLED), including a current buffer, a switching unit and a pulse width modulation grayscale control unit. The current buffer is connected to an external current source for providing constant current. The switching unit is connected to an external precharge voltage source, the current buffer and a GNDA, said switching unit also includes an output which is connected to the OLED. A pulse width modulation (PWM) grayscale control unit is connected to an external memory and the switching unit for controlling the grayscale display according to image data transmitted by the external memory after receiving a start signal in the scan period. Grayscale control complies with the display phases during the display period for division of grayscale display duration in proportion to the individual grayscales corresponding to the image data. Upon receiving image data, the driving device makes time control between the current buffer and the OLED in accordance with corresponding grayscale display duration to achieve the purpose of grayscale display control.

The present invention also provides a method to control display period for a grayscale display where display phases including precharge, display and discharge phases is set beforehand, comprising the steps of: First, image data are received. Then, calculate a grayscale display duration according to the image data. Next, precharge the OLED within the precharge phase, and then supply a constant current continuously to the OLED for the grayscale display until grayscale display duration is due. Discharge the OLED until the display phase is due. Finally, discharge the OLED until the discharge phase is due.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structure chart of the display system for display period control of organic light emitting diodes (OLED).

FIG. 2 is a function block diagram of an embodiment of the driving device for display period control of organic light emitting diodes (OLED).

FIG. 3 is a first diagram of display period for the present invention.

FIG. 4 is a second diagram of display period for the present invention.

FIG. 5 is a control flow chart of display period control of organic light emitting diodes (OLED).

### DETAILED DESCRIPTION OF THE PREFERRED EMBODIMENT

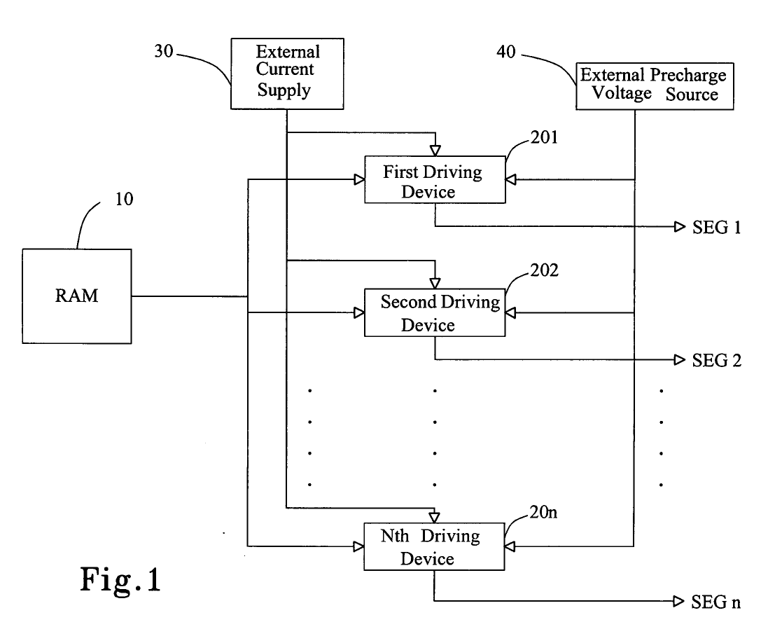

FIG. 1 discloses the driving system for OLED by applying the driving device of the present invention. The random access memory (RAM) 10 stores image data to be displayed, including the grayscale value of driving each OLED (connected to SEG 1˜n respectively). An external current source 30 provides constant current to every driving device and an external precharge voltage source 40 provides precharged voltage to each driving device. It is obvious to see in FIG. 1 that the first driving device 201, the second driving device 202 and the nth driving device 20n are connected to RAM 10, the external current source 30 and the external precharge voltage source 40 respectively. Every driving device is finally outputted to the OLED connected to each display period for controlling OLED display.

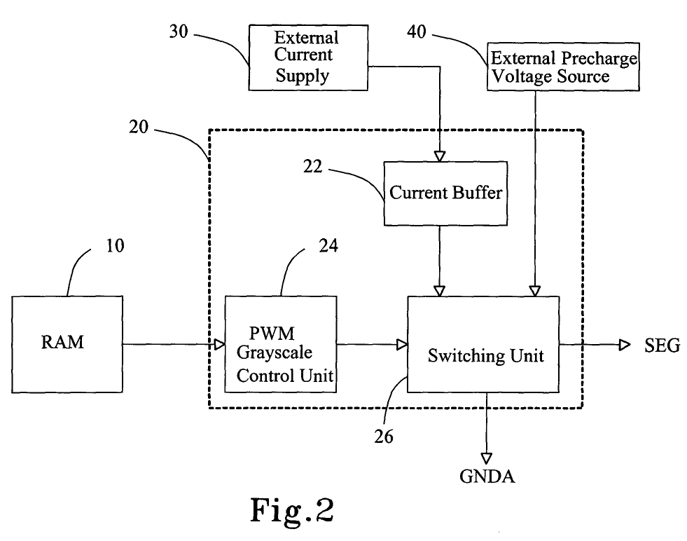

FIG. 2 illustrates the driving device for display period control of OLED Display, which can control the grayscale of the OLED of every scan period connected to the driving device and the operation flow of display period control.

As grayscale display control is one type of Pulse Width Modulation (PWM), a PWM grayscale control unit 24 is applied in the present invention. Each driving device 20 consists of a current buffer 22, the PWM grayscale control unit 24 and a switching unit 26. The PWM grayscale control unit 24 is connected to the RAM 10 to receive image data. The current buffer 22 is connected to the external current source 30 to control and to provide constant current to OLED. The switching unit 26 is connected to the external precharge voltage source 40, the current buffer 22, and an analog grounding (GNDA). The switching unit 26 also includes an output which is connected to the OLED.

The PWM grayscale control unit 24 controls not only the switching unit 26, but also switching duration, including a first duration required for connection between the external precharge voltage source 40 and the OLED during the precharge phase, a second duration containing grayscale display duration and display phase duration required for connection between the current buffer 22 and OLED, and a third duration, that is, discharge duration required for connection between GNDA and OLED. In other words, the PWM grayscale control unit 24 is in charge of the duration of the whole display period. The length of duration for each phase on three phases is fixed. Though the integral duration of the display phase is fixed; however, the grayscale display duration is transformed to the connection duration between the current buffer 22 and OLED according to the grayscale value given by the RAM 10. Moreover, the enable signal of the display phase is provided by an external circuit through another control line (not shown).

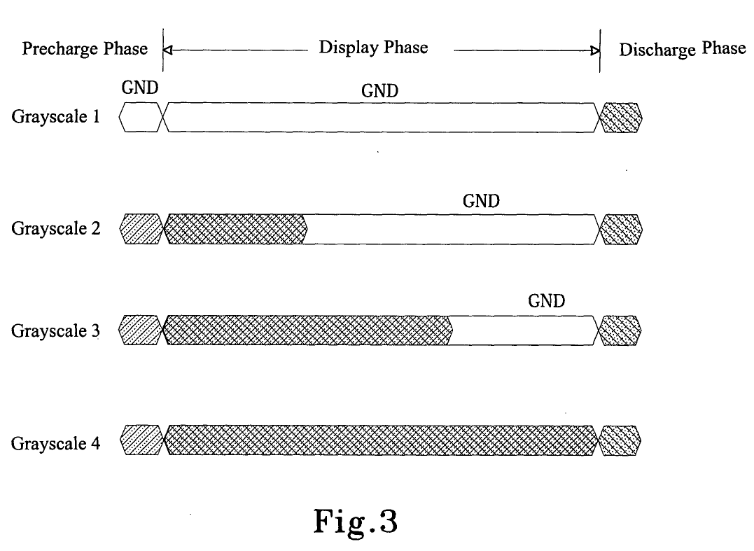

Grayscale display of the present invention is via controlling the connection time between the current buffer 22 and OLED. FIG. 3 disclosed the control principle of the PWM grayscale control unit 24. In which, two bits and four grayscales are used. First, set the precharge and discharge duration as fixed values in accordance with the specifications of the panel the manufacturer provides. Four-monochrome grayscale display can be obtained by dividing the connection duration between OLED and the current buffer during the display phase (i.e. OLED emitting time) into four different ratios. As FIG. 3 shows, duration during display phase is fixed; nevertheless, there are two states during the display phase, which are an ON state connected with the current buffer and a grounding state.

For grayscale 1, the OLED is grounded (GNDA) all the time during the display phase and the ON duration between the OLED and the current buffer 22 is zero leading to the least grayscale; that is non-luminance. For grayscale 2, the OLED and the current buffer 22 are ON for one third of the duration and grounded for two thirds of the duration with the second least grayscale. When it is in grayscale 3, the OLED and the current buffer 22 are ON for two thirds of the duration and grounded for one third of the duration with the second highest brightness. As for gray level 4, the OLED and the current buffer 22 are ON all through the display phase with the highest brightness. Thus, control is quite easy for the present invention as only one switching performance is required during the display phase.

Consequently, the same method can be applied by the present invention to achieve the purpose of grayscale control no matter how many bits of grayscale they are. For instance, grayscale display duration for a 3-bit grayscale is 0, 1/7, 2/7, 3/7 . . . 1 of the display phase. Time distribution for other bits is the same. As such control method is simple and practical, circuit design tends to become easier and less complicated.

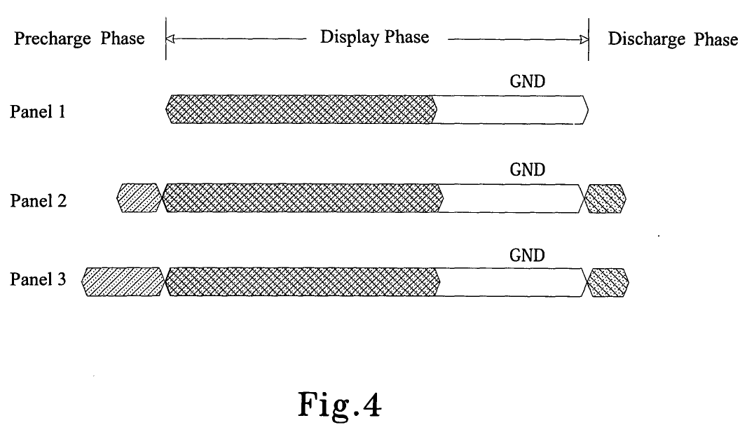

Furthermore, longer precharge duration is required for certain panels as they have a bigger load; however, precharge duration is not necessary for panels with a smaller loading capacity. Thus, different precharge and discharge duration can be designed for panels of different specifications so as to maintain good display quality of panels as FIG. 4 shows.

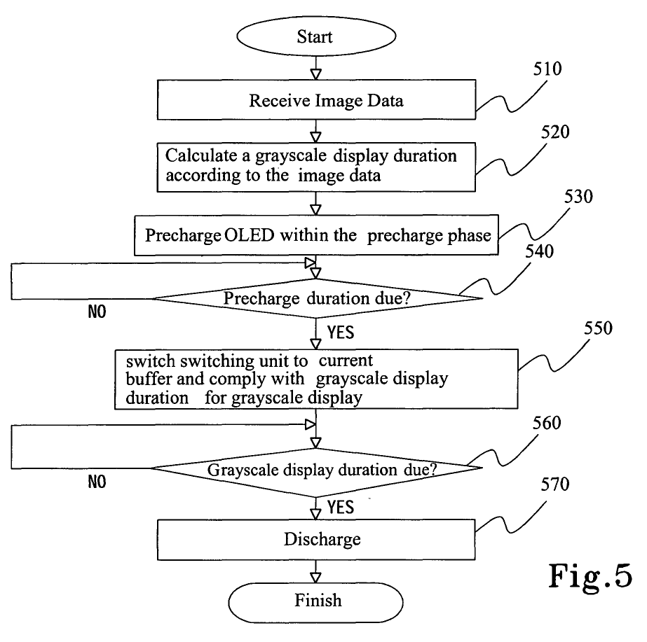

In fact, the present invention provides a method to control the display period of OLED for a grayscale display, where the display period including precharge, display and discharge phases, which are set beforehand. FIG. 5 discloses the specific flow including the steps as follows:

First, set up the precharge, display and discharge phases for a whole display period. Control will start after receiving enable signal. In the beginning, RAM 10 receives image data (Step 510). Next, calculate a grayscale display duration according to the image data (Step 520). When the grayscale display duration is obtained, grayscale display duration control during the display phase can be made. Next, precharge the OLED within the precharge phase (Step 530); i.e., the whole display period starts. Then, the PWM control unit 24 begins to supply a constant current continuously to the OLED for the grayscale display until the precharge duration (T1) is due (Step 540). Once the precharge duration is due, the PWM grayscale control unit 24 switches the switching unit 26 to the current buffer 22 and complies with the grayscale display duration for grayscale display (Step 550), shown as FIG. 3. That is to say, the PWM grayscale control unit 24 controls the switching unit 26 to connect the current buffer 22 to the output end (through SEG), and then controls the switching unit 26 to connect the output end (through SEG) to grounding (GNDA) for OLED discharge. Display control of conduction duration (T2) is in accordance with bits of the grayscale. The time of the display phase needs to be controlled so as to decide the grayscale display time (Step 560). When the grayscale display duration is due, discharge is made (Step 570), which means discharging begins when time (T3) is due no matter what display condition during the display phase is. Discharge duration (T4) is designed in compliance with specifications of the panel (corresponding to precharge duration), which coincides with FIG. 4.

The above steps describe the control flow of PWM grayscale control unit 24, which becomes possible through the design of the circuit as PWM grayscale control unit 24 of the present invention indicates.

Hardware design becomes simpler and less complicated by applying the driving device and driving method of the present invention. Besides, various precharge and discharge durations can be set for panels of different loading capacities to maintain good display quality of panels.

The present invention has been described using exemplary preferred embodiment. However, it is to be understood that the scope of the invention is not limited to the disclosed embodiments. On the contrary, it is intended to cover various modifications and similar specifications. The scope of the claims should be interpreted to involve all such modifications and specifications.

1. A driving device for display period control of organic light emitting diode (OLED), which can control the grayscale of said OLED of every scan period connected to said driving device, comprising:
a current buffer, connected to an external current source that provides constant current;
a switching unit, connected to an external precharge voltage source, said current buffer and a GNDA, said switching unit also includes an output which is connected to the OLED; and
a pulse width modulation (PWM) grayscale control unit, connected to an external memory and said switching unit for controlling said grayscale display according to image data transmitted by said memory after receiving a start signal in said scan period, which uses the steps of; connecting said precharge voltage source and said OLED during a first duration;
converting said grayscale of said image data to a grayscale display duration to control said switching unit for connecting said current buffer and said OLED;
controlling said switching unit for connecting said OLED and said GNDA until a second duration is due when said grayscale display duration is due;
controlling said switching unit for connecting said OLED and said GNDA until a third duration is due when said second duration is due;
wherein said display period is sum of said first, said second and said third durations.

2. The driving device for display period control of organic light emitting diode (OLED) according to claim 1, wherein said grayscale is more than 2 bits.

3. The driving device for display period control of organic light emitting diode (OLED) according to claim 1, wherein the conversion of said grayscale display duration is based on said grayscale for proportional of said second duration, for example, when said grayscale is 2 bits, said grayscale display duration is 0, ⅓, ⅔ and 1-time of said second duration; when said grayscale is 2 bits, said grayscale display duration is 1, 1/7, 2/7 and 1-time of said second duration, and so on.

4. The driving device for display period control of organic light emitting diode (OLED) according to claim 1, wherein said first duration is set according to panel types of said OLED.

5. A method for display period control of organic light emitting diode (OLED) for a grayscale display, where a display period including precharge, display and discharge phases is set beforehand, comprising the steps of:
receiving image data;
calculating grayscale display duration according to said image data;
precharging said OLED within the precharge phase;
supplying a constant current continuously to aid OLED for said grayscale display until grayscale display duration is due;
discharging said OLED until said display phase is due; and
discharging said OLED until said discharge phase is due.

6. The method for display period control of organic light emitting diode (OLED) according to claim 5, wherein said grayscale is more than 2 bits.

7. The method for display period control of organic light emitting diode (OLED) according to claim 5, wherein the calculation of said grayscale display duration is based on said grayscale for proportional of said display phase, for example, when said grayscale is 2 bits, said grayscale display duration is 0, ⅓, ⅔ and 1-time of said display phase; when said grayscale is 3 bits, said grayscale display duration is 1, 1/7, 2/7 and 1-time of said display phase, and so on.

8. The method for display period control of organic light emitting diode (OLED) according to claim 5, wherein said precharge phase is set according to panel types of said OLED.

9. A driving architecture for display period control of organic light emitting diode (OLED), which is to control grayscale of said OLED in every column or row scanned in the display matrix formed by several said OLEDs, said driving architecture is formed by a plurality of driving devices equivalent to the number of said OLEDs in the scanned column or row, each of said driving device comprising:
a current buffer, connected to a external current source that provides constant current;
a switching unit, connected to a external precharge voltage source, said current buffer and a GNDA, said switching unit also includes an output which is connected to the OLED; and
a pulse width modulation (PWM) grayscale control unit, connected to a external memory and said switching unit for controlling said grayscale display according to image data transmitted by said memory after receiving a start signal in said scan period, which uses the steps of;
connecting said precharge voltage source and said OLED during a first duration;
converting said grayscale of said image data to a grayscale display duration to control said switching unit for connecting said current buffer and said OLED;
controlling said switching unit for connecting said OLED and said GNDA until a second duration is due when said grayscale display duration is due; and
controlling said switching unit for connecting said OLED and said GNDA until a third duration is due when said second duration is due;
wherein said display period is sum of said first, said second and said third durations.

10. The driving architecture for display period control of organic light emitting diode (OLED) according to claim 9, wherein said grayscale is more than 2 bits.

11. The driving architecture for display period control of organic light emitting diode (OLED) according to claim 9, wherein the conversion of said grayscale display duration is based on said grayscale for proportional of said second duration, for example, when said grayscale is 2 bits, said grayscale display duration is 0, ⅓, ⅔ and 1-time of said second duration; when said grayscale is 2 bits, said grayscale display duration is 1, 1/7, 2/7 and 1-time of said second duration, and so on.

12. The driving architecture for display period control of organic light emitting diode (OLED) according to claim 9, wherein said first duration is set according to panel types of said OLED.
